(19) United States
(12) Patent Application Publication
(10) Pub. No.: US 2023/0022352 A1
(43) Pub. Date: Jan. 26, 2023

(54) DATA PRODUCT GENERATION AND PRODUCTION BASED ON DYNAMICALLY SELECTED/OBFUSCATED VEHICLE LOCATION

(71) Applicant: Wejo Limited, Manchester (GB)

(72) Inventor: Stuart CONSTANTINE, Liverpool (GB)

(21) Appl. No.: 17/381,774

(22) Filed: Jul. 21, 2021

(51) Int. Cl. G06Q 30/02; G06N 20/00; H04L 29/08; G01S 19/01

(52) U.S. Cl. CPC G06Q 30/0201; G06N 20/00; H04L 67/18; H04L 67/20; G01S 19/01

(57) ABSTRACT

A system configured to, and method of, transmitting connected vehicle data from a vehicle that includes carrying out a point of rest area learning process to obtain point of rest area(s); periodically obtaining a current geographical location of the vehicle; determining whether the vehicle is located within any of the point of rest area(s) based on the obtained geographical location; when it is determined that the vehicle is not located within any of the point of rest area(s), periodically transmitting the obtained geographical location; and when it is determined that the vehicle is located within any of the point of rest area(s), either transmitting an obfuscated geographical location or forgoing transmission of the obtained geographical location, wherein the obfuscated geographical location is an obfuscated representation of the obtained geographical location.

### TECHNICAL FIELD

This invention relates to methods and systems for streaming data from a very large number of vehicles to a remote data repository and generating data products based on the streaming data.

### BACKGROUND

Nowadays, large amounts of data is streamed from automobiles and other vehicles, and this data is used for various purposes, such as for providing traffic conditions of roads. Some vehicle data, such as its geographical position or location, is included in these vehicle data streams that are transmitted to a remote system, which may then store the data and/or package the data into a data product. Certain vehicle data may include or be used to derive sensitive information about one or more individuals, such as the owner or primary operator of the vehicle, and so this information may be anonymized. However, in general, anonymization of such data may lead to a reduction in precision of that data.

### SUMMARY

According to one aspect of the invention, there is provided a data product system for generating and providing a data product using data supplied by a multitude of vehicles, including: a remote data product system having one or more processors and memory storing remote data product computer instructions accessible by the one or more processors of the remote data product system; and a vehicle computer program product comprising in-vehicle computer instructions that are configured to be executed by a plurality of vehicles; wherein each of the plurality of vehicles includes vehicle electronics having one or more electronic processors that are configured to execute the in-vehicle computer instructions and, when the in-vehicle computer instructions are executed by the one or more electronic processors of the vehicle electronics, the vehicle electronics: carry out a point of rest area learning process to obtain one or more point of rest areas; periodically obtain a current geographical location of the vehicle; determine whether the vehicle is located within any of the one or more point of rest areas based on the obtained geographical location of the vehicle; when it is determined that the vehicle is not located within any of the one or more point of rest areas, periodically transmit the obtained geographical location of the vehicle; and when it is determined that the vehicle is located within any of the one or more point of rest areas, either transmit an obfuscated geographical location or forgo transmission of the obtained geographical location of the vehicle, wherein the obfuscated geographical location is an obfuscated representation of the obtained geographical location of the vehicle; wherein the remote data product system is configured so that, when the remote data product computer instructions are executed by the one or more electronic processors of the remote data product system, the remote data product system: receives connected vehicle data concerning the plurality of vehicles, wherein the connected vehicle data includes one or more geographical locations of the vehicle including the obtained geographical location of the vehicle; generates a data product using the connected vehicle data; and provides the data product to a third party.

According to various embodiments, the data product system may further include any one of the following features or any technically-feasible combination of some or all of the features:
when the in-vehicle computer instructions are executed by the one or more electronic processors of the vehicle electronics, the vehicle electronics transmit the obfuscated geographical location to the remote data repository when it is determined that the vehicle is located within any of the one or more point of rest areas;
the connected vehicle data concerning the plurality of vehicles includes at least one obfuscated geographical location including the obfuscated geographical location;
the determination of the point of rest area of the vehicle: determining whether a resting geographical location of the vehicle is within any of at least one previously-defined point of rest area; when it is determined that the resting geographical location of the vehicle is within any of the at least one previously-defined point of rest area, forgoing defining the point of rest area to be a new point of rest area; and when it is determined that the resting geographical location of the vehicle is not within any of the at least one previously-defined point of rest area, defining the point of rest area as a new point of rest area that is included in the one or more point of rest areas in addition to the at least one previously-defined point of rest area;
the new point of rest area of the vehicle is defined as an area of at least a predetermined size;
the predetermined size is defined based on demographics concerning a geographical location of the vehicle;
the point of reset area learning process includes: determining a dwell time of the vehicle during which the vehicle is stationary; and when the dwell time of the vehicle exceeds a predetermined threshold, determining a point of rest area of the vehicle based on a resting geographical location of the vehicle so that the point of rest area includes the resting geographical location of the vehicle, wherein the point of rest area is included as one of the one or more point of rest areas;
the point of rest area of the vehicle is defined as an area including the resting geographical location of the vehicle but where the resting geographical location is not necessarily at a center of the point of rest area;
the point of rest area of the vehicle is determined as a randomized area such that the resting geographical location of the vehicle is not necessarily located at a center of the point of rest area;
the point of rest area of the vehicle is determined as a randomized area such that a likelihood of the resting geographical location of the vehicle being located at a center of the point of rest area is the same as or comparable to a likelihood of the resting geographical location of the vehicle being located anywhere else within the point of rest area;
the in-vehicle computer instructions are downloaded to the each of the plurality of vehicles from a remote system;
the remote system is a digital distribution platform;
the remote system is an original equipment manufacturer (OEM) gateway or computer system;
the remote system is the remote data product system;
the in-vehicle computer instructions are downloaded to the each of the plurality of vehicles from the remote data product system via an original equipment manufacturer (OEM) gateway;
the point of rest area learning process includes: determining whether the resting geographical location of the vehicle is within a residential area and, when it is determined that the resting geographical location of the vehicle is not within a residential area, determining not to define a point of rest area;
determining that the vehicle repeatedly stops at a vehicle resting area; and when it is determined that the vehicle repeatedly stops at a vehicle resting area, determining a point of rest area of the vehicle so that the point of rest area includes at least a portion of the vehicle resting area, wherein the point of rest area is included as one of the one or more point of rest areas; and/or
the point of reset area learning process includes determining whether at least part of the vehicle resting area is within a residential area and, when it is determined that the at least part of the vehicle resting area is not within a residential area, determining not to define a point of rest area.

According to another aspect of the invention, there is provided a computer-readable memory, including computer instructions that, when executed by one or more electronic processors included as a part of vehicle electronics of a vehicle, cause the vehicle electronics to: carry out a point of rest area learning process to obtain one or more point of rest areas; periodically obtain a current geographical location of the vehicle; determine whether the vehicle is located within any of the one or more point of rest areas based on the obtained geographical location of the vehicle; when it is determined that the vehicle is not located within any of the one or more point of rest areas, periodically transmit the obtained geographical location of the vehicle; and when it is determined that the vehicle is located within any of the one or more point of rest areas, either transmit an obfuscated geographical location or forgo transmission of the obtained geographical location of the vehicle, wherein the obfuscated geographical location is an obfuscated representation of the obtained geographical location of the vehicle.

According to yet another aspect of the invention, there is provided a method of transmitting connected vehicle data from a vehicle to a remote data repository, wherein the method is carried out as a result of executing computer instructions using one or more electronic processors included as a part of vehicle electronics of a vehicle, wherein the method includes the steps of: carrying out a point of rest area learning process to obtain one or more point of rest areas; periodically obtaining a current geographical location of the vehicle; determining whether the vehicle is located within any of the one or more point of rest areas based on the obtained geographical location of the vehicle; when it is determined that the vehicle is not located within any of the one or more point of rest areas, periodically transmitting the obtained geographical location of the vehicle; and when it is determined that the vehicle is located within any of the one or more point of rest areas, either transmitting an obfuscated geographical location or forgoing transmission of the obtained geographical location of the vehicle, wherein the obfuscated geographical location is an obfuscated representation of the obtained geographical location of the vehicle.

### BRIEF DESCRIPTION OF THE DRAWINGS

Preferred exemplary embodiments will hereinafter be described in conjunction with the appended drawings, wherein like designations denote like elements, and wherein:

FIG. 1 depicts a communications system that includes a data product system and a plurality of vehicles, according to one embodiment;

FIG. 2 depicts a block diagram illustrating components of the communications system of FIG. 1, according to one embodiment;

FIG. 3 is a flowchart of a method of learning a point of rest area interest for a vehicle, according to one embodiment;

FIG. 4 is a flowchart of a method of transmitting connected vehicle data from a vehicle to a remote data repository, according to one embodiment; and

FIG. 5 is a flowchart of a method of generating and providing a data product using data supplied by a multitude of vehicles, according to one embodiment.

### DETAILED DESCRIPTION

The system and method described herein enables generating a data product based on connected vehicle data streamed from a plurality of vehicles, where the connected vehicle data includes the geographical location of the vehicle during travel but where the obtained geographical location of the vehicle is obfuscated or not included in the connected vehicle data when the vehicle is at or near a point of rest. According to at least some embodiments, the data product system is configured to transmit a connected vehicle data stream where the connected vehicle data stream selectively includes geographical locations of the vehicle, such as those obtained from a global navigation satellite system (GNSS), or obfuscated representations of geographical locations, which are referred to herein as “obfuscated geographical locations.” In at least some embodiments, the vehicle is configured to obfuscate or exclude geographical locations of the vehicle when it is determined that the vehicle is within any point of rest area, which is a defined area that includes a resting geographical location of the vehicle, such as an area surrounding a vehicle user's residence and in an example a vehicle user's workplace. By obfuscating or excluding these geographical locations that are within any point of rest area, the system and method described herein is able to provide a real-time data product while also anonymizing the underlying data so that individual identities of vehicle users are protected. Thus, according to at least some embodiments, the system and method provided herein enable geographical locations at or near a point of rest of the vehicle to be excluded from the connected vehicle data or to be obfuscated prior to being included in the connected vehicle data that is streamed from the vehicle to a remote data repository or system. This streamed connected vehicle data or data derived therefrom is then included in the data product.

As used herein, a “real-time” data product is a data product that is continuously generated and transmitted out to one or more customers as data is received by the product data system. The length of time during which this continuous process occurs may vary depending on the needs of the customer and/or based on other factors. This length of time could be minutes or hours or days at a time. In some embodiments, real-time may refer to the use of “live data” which is defined herein as data for which the mean total time taken by a plurality (two or more) or multitude (1,000 or more) of sequential connected vehicle data points to be transmitted from the vehicle, received at the data product system, and incorporated into (or obfuscated/rejected from) the real-time data product is equal to 120 seconds or less. In some embodiments, the processing carried out at the data product system may be done instantaneously or near-instantaneously, where “instantaneous” means the mean is less than twenty seconds and “near-instantaneous” means the mean is less than forty-five seconds. The instantaneous and near-instantaneous processing may be considered to occur in real-time.

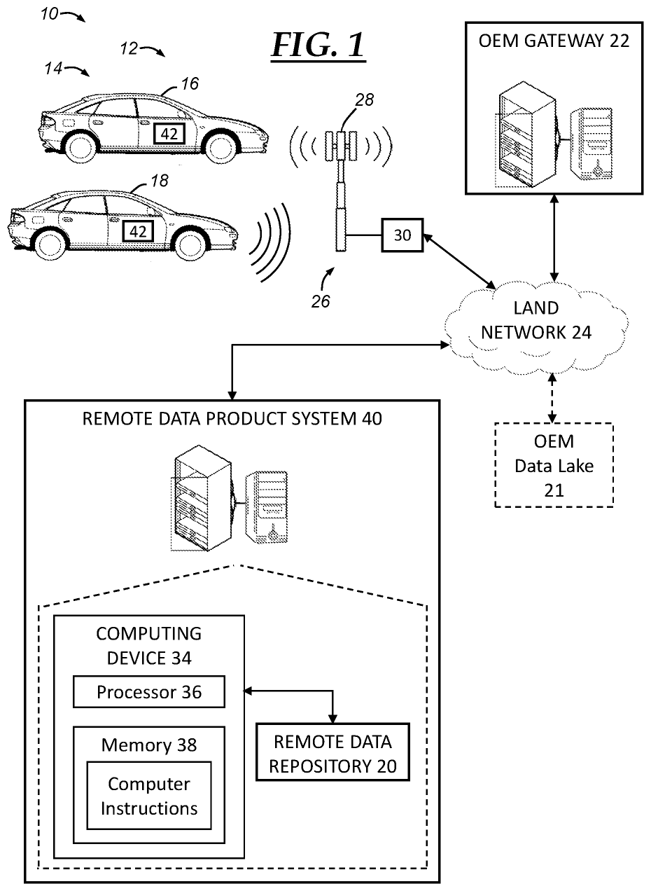

With reference now to FIG. 1, there is shown a communications system 10 that includes a data product system 12 having a remote data product system 40 and in-vehicle computer programs 42, a plurality of vehicles 14 including a first vehicle 16 and a second vehicle 18, an OEM data repository or data lake 21, an OEM gateway 22, a land network 24, and a wireless carrier system 26. Although only two vehicles are shown, it will be appreciated that the system is intended to be capable of working with a multitude of vehicles 14 (i.e., at least 1,000 vehicles) and even with millions of vehicles 14. Also, as used herein, the “vehicles” with which the data product system is used are connected vehicles (CVs) that are capable of wireless communication of data from the vehicle to a data lake or other remote data repository. It should be appreciated that while the illustrated embodiment of FIG. 1 provides an example of one such communications system 10, the data product system 12 and method(s) described below may be used as a part of various other communications systems.

The land network 24 may be a conventional land-based telecommunications network that is connected to one or more landline telephones and connects the wireless carrier system 26 to the remote data product system 40, the OEM data lake 21, and the OEM gateway 22. For example, the land network 24 may include a public switched telephone network (PSTN) such as that used to provide hardwired telephony, packet-switched data communications, and the Internet infrastructure. One or more segments of the land network 24 could be implemented through the use of a standard wired network, a fiber or other optical network, a cable network, power lines, other wireless networks such as wireless local area networks (WLANs), or networks providing broadband wireless access (BWA), or any combination thereof.

The wireless carrier system 26 may be any suitable cellular telephone system. The wireless carrier system 26 is shown as including a cellular tower 28; however, the wireless carrier system 26 may include additional cellular towers as well as one or more of the following components (e.g., depending on the cellular technology): base transceiver stations, mobile switching centers, base station controllers, evolved nodes (e.g., eNodeBs), mobility management entities (MMEs), serving and PGN gateways, etc., as well as any other networking components used to connect the wireless carrier system 26 with the land network 24 or to connect the wireless carrier system 26 with user equipment (UEs, e.g., which may include telematics equipment in the vehicles 14), all of which is indicated generally at 30. The wireless carrier system 26 may implement any suitable communications technology, including for example GSM/GPRS technology, CDMA or CDMA2000 technology, LTE technology, 5G, etc. In general, the wireless carrier system 26, its components, the arrangement of its components, the interaction between the components, etc. is generally known in the art.

The remote data repository 20 is used to store data received from the vehicles 14. For example, the vehicles 14 may each be configured to transmit data, which may be a part of a data stream, to the remote data repository 20 via the wireless carrier system 26 and the land network 26, and the remote data repository 20, upon receiving the data, may store the data. The remote data repository 20 is shown as a part of the data product system 12, which may be owned and operated by an independent commercial partner of one or more of the vehicle original equipment manufacturers (OEMs). In other embodiments, the data repository may be any publicly or privately accessible aggregation of stored data, which can be structured or unstructured data and which is accessible over a global communications network such as the internet. For example, as optionally shown in FIG. 1, the OEM may have its own data lake (repository) 21 to which the data from the vehicles are initially stored and then accessed (e.g., in real-time) by the remote data product system 40 to generate the data product(s). However implemented, the remote data repository is remote in the sense that it is remote from the vehicles 14, but in some embodiments may be co-located with the remote data product system 40 (as shown) and/or with the OEM gateway 22. The remote data repository 20 may be, for example, one or more databases, data lakes, data warehouses, or some combination thereof. The OEM data lake 21 is also considered a remote data repository in the sense that it is remote from the vehicles 14.

In some embodiments, the OEM may provide the remote data product system 40 with direct access to the vehicles; for example, by enabling direct streaming of data from the vehicles 14 to the remote data product system 40, rather than via the OEM gateway 22 (and/or optional OEM data lake 21). This may be done by providing the data product system 12 the necessary credentials and access to the vehicles' communications system 104, and techniques for doing that will be known to those skilled in the art.

The OEM gateway 22 is a computer system that operates as an interface between the vehicles 14 and the remote data product system 40. The OEM gateway 22 may be operated, managed, owned, and/or controlled (collectively “managed”) by an OEM. The OEM gateway 22 may be implemented as computer instructions that are executed by one or more computers or computing devices. In one embodiment, the OEM gateway 22 is configured to receive requests from the remote data product system 40 and to determine whether to grant or forward those requests to one or more of the vehicles 14. The OEM gateway 22 may implement certain rules or logic to determine whether a particular request from the remote data product system 40 should or should not be granted.

The data product system 12 includes the in-vehicle computer programs 42 and the remote data product system 40, which is a centralized or distributed computer system that is used to generate one or more data products having connected vehicle data or data derived therefrom. In at least some embodiments, the data product system 12 is operated, managed, owned, and/or controlled by a data product party, which is a party that is separate than the OEM that manages the OEM gateway 22. The remote data product system 40 is shown as including the remote data repository 20 as well as a computing device 34 having an electronic processor 36 and computer-readable memory 38. As used herein an “electronic processor” is a physical processing device that operates under electrical power to execute computer instructions. These computer instructions are stored on the computer-readable memory 38 which is accessible by the electronic processor 36 so that the electronic processor 36 may execute the computer instructions stored on the memory 38. Although the remote data product system 40 is illustrated as including a single computing device 34, it should be appreciated that, in other embodiments, the remote data product system 40 includes a plurality of computing devices 34, each of which has an electronic processor and memory. Moreover, in at least some embodiments, the remote data product system 40 may be provisioned across numerous instances and the functionality described herein as being carried out by the remote data product system 40 may be carried out in a distributed fashion, such as by one or more computing devices that may or may not be co-located with one another. And, according to some embodiments, the computing device 34 of the remote data product system 40 may be located remotely from the remote data repository 20 or, in other embodiments, may be co-located with the remote data repository 20. Additionally, it should be appreciated that the computer instructions of the remote data product system 40 may be stored on one or more memories and/or executed by one or more electronic processors, even though FIG. 1 depicts a single electronic processor and memory.

The plurality of vehicles 14 is illustrated as including at least the first vehicle 16 and the second vehicle 18, each of which is depicted in the illustrated embodiment as a passenger car, but it should be appreciated that any other vehicle including motorcycles, trucks, sports utility vehicles (SUVs), recreational vehicles (RVs), other vehicles or mobility devices that can be used on a roadway or sidewalk, boats, other marine vessels, planes, unmanned aerial vehicles (UAVs), other aerial vehicles, etc., can also be used. Although FIG. 1 only depicts two vehicles 16, 18, it should be appreciated that the vehicles 14 may include any number of vehicles. In some embodiments, the data product system 12 is used to generate data products having data aggregated from information concerning a large number of vehicles and, in such embodiments, the communications system 10 may include a multitude of vehicles, which, as used herein, means at least one thousand (1,000) vehicles.

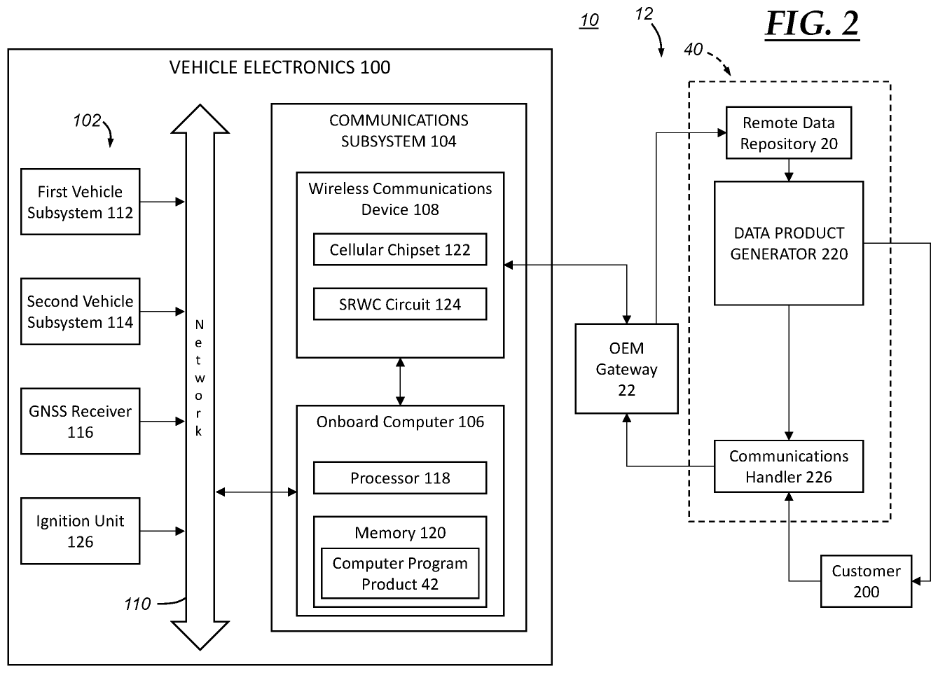

With reference to FIG. 2, there is shown detailed portions of the communications system 10, including vehicle electronics 100 that may be used as a part of the vehicles 14. The vehicle electronics 100 are electronics that include one or more subsystems and/or components that are installed on a vehicle, such as the first vehicle 16 and the second vehicle 18. Although FIG. 2 depicts certain components and subsystems as being a part of the vehicle electronics 100, it should be appreciated that the vehicle electronics 100 may include various other components and/or subsystems in addition to or in lieu of those components and subsystems specifically shown in FIG. 2.

The vehicle electronics 100 includes a plurality of vehicle subsystems 102, a communications subsystem 104 having an onboard computer 106 and a wireless communications device 108, a communications network 110, a global navigation satellite system (GNSS) receiver 116, and an ignition unit 126. The plurality of vehicle subsystems 102 is shown as including a first vehicle subsystem 112 and a second vehicle subsystem 114; however, it should be appreciated that, in other embodiments, the plurality of vehicle subsystems 102 may include any suitable number of vehicle subsystems. In one embodiment, the first vehicle subsystem 112 may be an engine controller and the second vehicle subsystem 114 may be a body computer. Of course, any vehicle subsystem that provides data over the vehicle's bus (e.g., over communications network 110) or that otherwise provides data accessible by the communications subsystem 104 may be used as a data source for data items sent to the remote data repository.

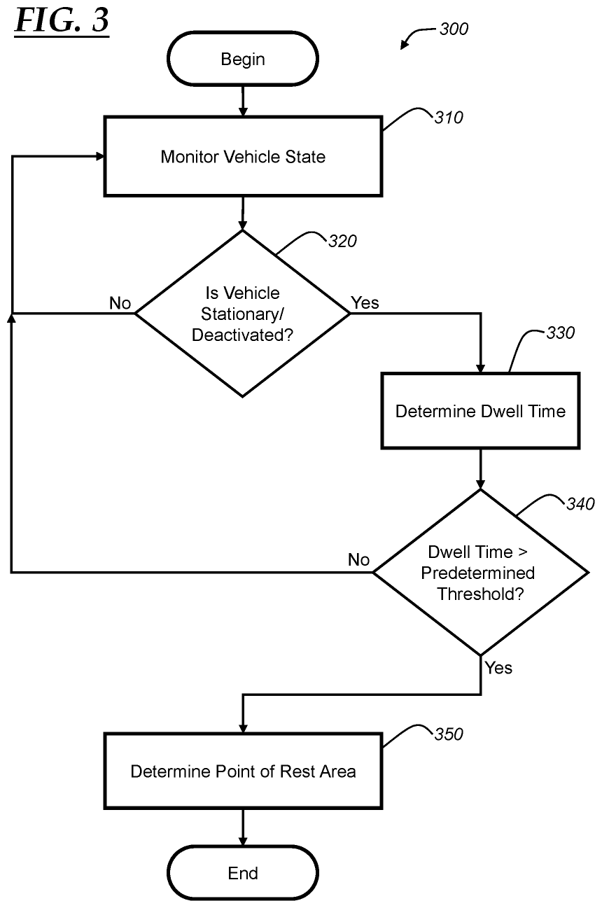

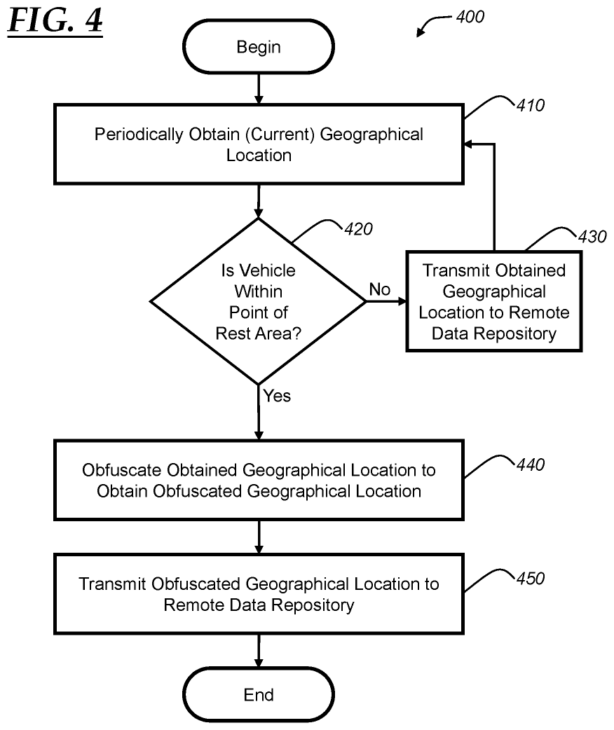

The communications subsystem 104 includes the wireless communications device 108 and is connected within the vehicle electronics 100 such that the data from the vehicle subsystems 102 is accessible by the communications subsystem 104. The communications subsystem 104 is also shown as including the onboard computer 106, which may be used to carry out various processing of the communications subsystem 104, such as that which is described below as being a part of method 300 (FIG. 3) and the method 400 (FIG. 4). It should be appreciated that, although various processing of the communications subsystem 104 and/or the vehicle electronics 100 is described as being carried out by the onboard computer 106, in one or more embodiments, the processing described herein as being attributed to the onboard computer 106 may be carried out by one or more other computers of the vehicle electronics 100, including those that may or may not be considered as forming a part of the communications subsystem 104. Moreover, although the onboard computer 106 is shown and described as being separate from the wireless communications device 108, in one embodiment, the onboard computer 106 and the wireless communications device 108 are integrated into a single device or module. Also, although the onboard computer 106 and the wireless communications device 108 are illustrated as being directly coupled to one another, in other embodiments, the onboard computer 106 and the wireless communications device 108 may be coupled to each other via the communications network 110 or other suitable electronic communication connection.

The onboard computer 106 includes an electronic processor 118 and computer-readable memory 120 having the in-vehicle computer program 42. The memory 120 is operatively coupled to the electronic processor 118 so that the electronic processor 118 may access contents of the memory 120, including the in-vehicle computer instructions that are used to form the in-vehicle computer program 42. The electronic processor 118 is configured to execute the in-vehicle computer instructions, which, in at least one embodiment, cause the method 300 (FIG. 3) and/or the method 400 (FIG. 4) to be carried out.

The wireless communications device 108 is used to provide remote network connectivity to the vehicle electronics 100. The wireless communications device 108 is illustrated as including a cellular chipset 122 and a short range wireless communication (SRWC) circuit 124. However, in other embodiments, the wireless communications device 108 may include only one of the cellular chipset 122 and the SRWC circuit 124. Long-range or remote data communications may be carried out by the wireless communications device 108, such as for purposes of transmitting streaming data to the remote data repository 20. The cellular chipset 122 may be used to provide internet connectivity to the vehicle electronics 100 through establishing communications with the cellular tower 28 of the wireless carrier system 26.

The SRWC circuit 124 enables the vehicle to send and receive wireless messages using one or more SRWC technologies, such as Wi-Fi™, Bluetooth™, IEEE 802.11p, other vehicle to infrastructure (V2I) communications, vehicle to vehicle (V2V) communications, other vehicle to everything (V2X) communications, etc. In one embodiment, the SRWC circuit 124 may be used to connect to a wireless access point hosted by another device, such as a wireless communication device included as a part of roadside equipment or a wireless router located at a vehicle user's residence, which may then provide internet or remote network connectivity. For example, the SRWC circuit 124 may transmit data from the vehicle to the remote data repository 20 and/or the OEM gateway 22 via a Wi-Fi™ connection between the wireless communications device 108 and a wireless router/modem, which is then connected to the internet, such as by way of land network 24.

The communications network 110 is an in-vehicle communications network that communicatively couples two or more components or subsystems of the vehicle electronics 100 to each other so that the two or more components may carry out communications. In the illustrated embodiment of FIG. 2, the communications network 110 is shown as communicatively coupling each of the plurality of subsystems 102 to the communications subsystem 104 and, specifically, the onboard computer 106. In one embodiment, the communications network 110 is implemented as one or more hardwired communication network busses, such as those used for providing a controller area network (CAN), a media oriented system transfer (MOST), a local interconnection network (LIN), a local area network (LAN), and/or other appropriate networks, such as those that use Ethernet or others that conform with known ISO, SAE and IEEE standards and specifications, to name but a few. In one embodiment, the communications network 110 may be implemented as a wireless LAN that uses Wi-Fi™, other IEEE 802.11 technology, or other suitable wireless networking technology.

The global navigation satellite system (GNSS) receiver 116 includes hardware enabling the GNSS receiver 116 to receive GNSS signals transmitted by a constellation of GNSS satellites (not shown). In some embodiments, the GNSS receiver 116 may be a global positioning system (GPS) receiver that receives GPS signals from GPS satellites that are a part of the United States' GPS satellite system. GNSS receivers for use with GLONASS, Europe's Galileo system, or other global positioning system may also be used as the GNSS receiver 116. The GNSS receiver 116 uses the received GNSS signals to obtain GNSS data, which provides a geographical location of the vehicle. In at least some embodiments, the term “geographical location” refers to a location that is derived from GNSS data and, in at least one embodiment, a location that may be specified as a latitudinal and longitudinal coordinate pair. In other embodiments, “geographical location” refers to a location that may be determined in another suitable way without use of GNSS data. A current geographical location of the vehicle may be periodically determined by the GNSS receiver 116 and transmitted over the communications network 110 so that other components of the vehicle electronics 100, such as the onboard computer 106, may obtain the current geographical location of the vehicle. In at least some embodiments, the current geographical location may be specified at a particular resolution where the particular resolution is the same resolution that the GNSS receiver 116 is configured to provide.

The ignition unit 126 is electronic hardware that is used to control the ignition of the vehicle, and to transmit an ignition status of the vehicle over the communications network 110. The ignition status indicates whether the ignition of the vehicle is activated (i.e., the vehicle is running) or deactivated (i.e., the vehicle is not running). The ignition status is a form of a primary mover status that indicates whether a primary mover of the vehicle is activated or deactivated.

In other embodiments, such as where the vehicle is an electric vehicle (EV), the vehicle electronics 100 may not include the ignition unit 126, but may instead include a primary mover controller that controls, for example, one or more electric motors used for propelling the vehicle. The primary mover controller may provide a primary mover status indicating whether the vehicle is activated or deactivated. In one embodiment, the primary mover status may indicate that the vehicle is stationary, that the vehicle is moving, that the vehicle is in a ready state in which it is responsive to a user throttle input, etc. According to various embodiments, any one or more of these vehicle states may be considered as indicating that the primary mover is activated or deactivated. Of course, other vehicle data may be used to indicate whether the primary mover is activated or deactivated.

In one embodiment, the onboard computer 106 is configured to obtain certain data communicated over the communications network 110 and, in a particular embodiment, to obtain certain data provided over one or more hardwired communication network busses. In particular, the onboard computer 106 may be configured to obtain location data from the GNSS receiver 116. As will be described in more detail below, each of the vehicles 14 may obtain data that is then streamed as a data stream that is transmitted to the remote data repository 20 (or otherwise streamed to a remote system so that this data is accessible to the remote data product system 40). According to at least some embodiments, the onboard computer 106 is configured to carry out the method 300 (FIG. 3) and the method 400 (FIG. 4).

As is also shown in FIG. 2, the remote data product system 40 includes the remote data repository 20, a data product generator 220, and a communications handler 226. The data product generator 220 is used to generate a data product based on connected vehicle data obtained or derived from the remote data repository 20 or otherwise obtained from the vehicles 14. The data product may then be provided to the data product customer 200. As used herein, a “data product” is data derived or otherwise obtained from a collection of data streamed as a part of one or more data streams that are transmitted from a group of vehicles to a remote data repository or system. In some embodiments the data product is containerized or packaged data according to a custom or standardized format or protocol. In one embodiment, various processing may be performed on the data of the data streams for purposes of obtaining data to be included as a part of the data product. For example, the data product generator 220 may obtain data stored in the remote data repository 20 and/or a part of a data stream and perform various processing, such as obfuscation and/or analytics, on this obtained data so as to generate processed data that is then packaged into a data product. In other embodiments, the data product generator 220 may receive processed data from another device, module, or system that obtains and processes data stored in the remote data repository 20 and/or received as a part of a data stream. And, in some embodiments, the data product generator 220 may receive processed data and also carry out further processing on this processed data, the result of which may then be included in the data product.

The communications handler 226 is used to initiate carry out communications with the OEM gateway 22 and/or one or more of the vehicles 14. The communications handler 226 may be used for receiving data product request data from the data product customer 200. The data product request data may be data indicating which data is to be (or requested to be) included in a data product that is requested by the data product customer 200. The data product request data may be provided to the communications handler 226 directly from the data product customer 200, such as through an application programming interface (API), or may be provided from the data product customer 200 to a person of the party managing the data product system 12. In the latter case, the person may input the data product request data into the data product system 12 such that it is accessible by the communications handler 226.

The communications handler 226 may initiate a request to be sent to a subset of the vehicles 14 directly by sending the request to the subset of vehicles. In other embodiments, the communications handler 226 may initiate a request to be sent to a subset of the vehicles 14 by sending one or more messages to the OEM gateway 22, which may deny or grant the request. If granted, the OEM gateway 22 may then send the request to the subset of vehicles. The request, when received at the subset of vehicles, may cause each of the subset of vehicles to make a change to a data stream, such as to change the data capture and/or transmission rate, to change which data is being sent, or some combination thereof.

In one embodiment, the communications handler 226 is used to provide the in-vehicle computer instructions that make up the in-vehicle computer programs 42. And, in some embodiments, the communications handler 226 is used to provide updates to the in-vehicle computer instructions that make up the in-vehicle computer programs 42, such as to update parameters used as a part of the method 300 (FIG. 3) and/or the method 400 (FIG. 4). For example, one or more parameters used to define a point of rest area, such as a radius or size of the point of rest area, may be transmitted to the vehicle and used as a part of determining the point of rest area, as described in step 350 of the method 300 (FIG. 3). As another example, one or more parameters used to define a predetermined dwell time threshold may be transmitted to the vehicle and used as a part of step 340 of the method 300 (FIG. 3), for example.

Each of the data product generator 220 and the communications handler 226 may be implemented as executable computer instructions that, when executed by one or more electronic processors of the data product system 12 (e.g., the electronic processor 36 of the computing device 34), cause the data product system 12 to carry out the functionality described herein as being attributed to the data product generator 220 and the communications handler 226, respectively. Specifically, for example, the data product system 12 may include data product generator computer instructions that, when executed, cause the functionality attributed to the data product generator 220 to be carried out.

Any one or more of the electronic processors discussed herein may be implemented as any suitable electronic hardware that is capable of processing computer instructions and may be selected based on the application in which it is to be used. Examples of types of electronic processors that may be used include central processing units (CPUs), graphics processing units (GPUs), field-programmable gate arrays (FPGAs), application specific integrated circuits (ASICs), microprocessors, microcontrollers, etc. Any one or more of the non-transitory, computer-readable memory discussed herein may be implemented as any suitable type of memory that is capable of storing data or information in a non-volatile manner and in an electronic form so that the stored data or information is consumable by the electronic processor. The memory may be any a variety of different electronic memory types and may be selected based on the application in which it is to be used. Examples of types of memory that may be used include including magnetic or optical disc drives, ROM (read-only memory), solid-state drives (SSDs) (including other solid-state storage such as solid-state hybrid drives (SSHDs)), other types of flash memory, hard disk drives (HDDs), non-volatile random access memory (NVRAM), etc. It should be appreciated that the computers or computing devices may include other memory, such as volatile RAM that is used by the electronic processor, and/or may include multiple electronic processors.

With reference to FIG. 3, there is shown an embodiment of a method 300 of learning a point of rest area interest for a vehicle. The method 300 is carried out by the vehicle electronics 100 and, in particular and at least according to some embodiments, by the communications subsystem 104 of the vehicle electronics 100. In at least one embodiment, the method 300 is carried out by a vehicle as a result of executing the in-vehicle computer instructions that form the in-vehicle computer program 42. The method 300 represents one embodiment of a point of rest area learning process that may be used to learn one or more point of rest areas. While the steps of the method 300 are described with respect to learning a single point of rest area, it should be appreciated that the method 300 (or one or more steps thereof) may be carried out numerous times so that numerous point of rest areas are learned. According to some embodiments, the method 300, or the point of rest area learning process, may be carried out continuously by the vehicle electronics 100 when the vehicle electronics 100 are in a point of rest area learning mode. The vehicle electronics may be configured to be or placed in the point of rest area learning mode for a predetermined amount of time or number of days after the vehicle is transferred to a new vehicle user or owner, such as at the time of an initial sale or lease of the vehicle. Additionally or alternatively, according to some embodiments, a vehicle user may use one or more input devices of the vehicle electronics so as to place the vehicle electronics in the point of rest area learning mode. And, additionally or alternatively, according to some embodiments, the vehicle electronics may be placed in the point of rest area learning mode in response to or as a result of receiving an instruction or request to do so from the remote data product system 40 or other component of the system remote from the vehicle.

The method 300 begins with step 310, wherein the vehicle state is monitored and, in at least some embodiments, this includes monitoring an in-vehicle communications network, such as the communications network 110, to determine whether the vehicle is traveling or stationary. In some embodiments, the determination of whether the vehicle is traveling or stationary includes determining whether a primary mover of the vehicle is activated or deactivated. In one embodiment, data representing or indicating a primary mover status is obtained by the onboard computer 106 and inspected to determine whether a primary mover of the vehicle is activated or deactivated. For example, in one embodiment, the ignition unit 126 transmits an ignition status over the communications network 110 and then the onboard computer 106 receives the ignition status and determines whether the ignition is activated or deactivated. In another embodiment, data indicating vehicle movement over time, such as GNSS data or wheel speed as indicated by data from a wheel speed sensor, may be used to determine whether the vehicle is traveling or stationary. For example, in one embodiment, the onboard computer 106 may continuously monitor GNSS data, such as one or more geographical locations and associated time data provided by the GNSS receiver 116, to determine whether the GNSS data indicates that the vehicle has moved more than a predetermined distance—in this example, when it is determined that the vehicle has moved more than the predetermined distance, then the vehicle may be considered as not being stationary. In some embodiments, a combination of data indicating whether the vehicle is traveling or stationary may be used. As shown at step 320, when it is determined that the vehicle is stationary, the method 300 continues to step 330; otherwise, the method 300 continues back to step 310.

In step 330, a dwell time is determined. The dwell time is a continuous period of time in which the vehicle remains stationary. As shown in step 340, when the dwell time exceeds a predetermined threshold amount, the method 300 continues to step 350. In one embodiment, a start time of a dwell period is determined as being when the vehicle is first determined to be stationary, such as when the vehicle ignition is deactivated and/or when the vehicle speed is determined to be below a predetermined threshold. In such embodiments, for example, an end time of the dwell period is determined as being when the vehicle is determined to be moving or traveling, such as when the vehicle speed is determined to be above a predetermined threshold or when the ignition of the vehicle is activated by the ignition unit 126. In some embodiments, instead of defining a particular start and end time of a dwell period corresponding to the dwell time, a dwell timer may be used. In such embodiments, for example, the dwell timer may be initiated/started when the vehicle is first determined to be stationary and continuously monitored to determine whether the dwell timer (and, thus, the dwell time) exceeds the predetermined threshold amount. When it is determined that the dwell time exceeds the predetermined threshold amount, the method 300 continues to step 350.

In other embodiments, instead of or in addition to the steps of determining a dwell time and determining whether the dwell time exceeds a predetermined threshold amount, the vehicle may determine whether the vehicle repeatedly stops at a vehicle resting area. As used herein, a vehicle resting area is an area that is defined based on a location at which the vehicle is stationary and/or deactivated. For example, in one embodiment, the vehicle 16,18 may determine a resting geographical location based on GNSS data received at the GNSS receiver 116 and, then, a vehicle resting area may be determined based on that resting geographical location, such as by defining a circular area that includes the resting geographical location as the center and where the radius is a predetermined distance. As another example, the vehicle 16,18 may determine a vehicle resting area based on a user-defined location, such as a residential address of the user, and/or based on other location-determining implements, such as detection of the presence of a particular device (e.g., detection of a service set identifier (SSID) of a wireless router). In some embodiments, the bounds of the vehicle resting area are not specifically defined at a particular point in time, but the vehicle is considered to be within the same vehicle resting area as the vehicle was previously within when the resting geographical location at the present time and the resting geographical location of a previous time or iteration are within a predetermined distance of one another, such as within 100 meters. This may be particularly useful in scenarios in which the vehicle resting area corresponds to a workplace of the vehicle user since, as is oftentimes the case, the vehicle is not necessarily parked in the same parking spot at the workplace, but rather in the same parking lot or general area surrounding the workplace.

Accordingly, in some embodiments, in place of step 330 is a step of determining whether the vehicle 16,18 is within the vehicle resting area and in place of step 340 is a step of determining a point of rest area when the vehicle repeatedly stops within the vehicle resting area. When the vehicle stops or is deactivated, the vehicle 16,18 may then determine whether the vehicle 16,18 is within the vehicle resting area (an alternative for step 330) and, based on whether the vehicle 16,18 is within the vehicle resting area, then the vehicle may increment a count for the vehicle resting area that the vehicle is located within. When the count for a given vehicle resting area exceeds a predetermined threshold amount, then a point of rest area may be determined so that the point of rest area includes at least a portion of the vehicle resting area and, in one embodiment, includes the entire vehicle resting area. In one embodiment, the point of rest area is defined based on one or more resting geographical locations of the vehicle, where the one or more resting geographical locations of the vehicle are within the vehicle resting area. And, in another embodiment, the point of rest area may be defined based on other data associated with the vehicle resting area, such as a residential location of the vehicle user, which may be preset by the user or inferred/determined by the vehicle, such as through use of map-matching techniques applied to the resting geographical location(s) of the vehicle.

In step 350, a point of rest area is determined based on a resting geographical location of the vehicle. The point of rest area is an area that includes the resting geographical location of the vehicle. The resting geographical location of the vehicle is a geographical location of the vehicle at which the vehicle is stationary. In response to determining that the vehicle is stationary (step 320), a current geographical location of the vehicle may be determined, such as based on GNSS signals received at the GNSS receiver 116, and then this obtained (current) geographical location may be used as the resting geographical location. In another embodiment, the resting geographical location may be determined at another suitable time, such as at the time when the dwell is determined to exceed the predetermined threshold.

After the resting geographical location is determined, the point of rest area may be defined. In one embodiment, this step 350 includes determining whether the resting geographical location of the vehicle is within any of at least one previously-defined point of rest area. The at least one previously-defined point of rest area may include those point of rest areas that were defined as a result of previous iterations of the point of area learning process or that were predefined, such as at the time of initial sale, lease, or registration with the OEM and/or the data product system 12. In at least some embodiments, when it is determined that the resting geographical location of the vehicle is within any of the at least one previously-defined point of rest area, forgoing defining the point of rest area to be a new point of rest area; and when it is determined that the resting geographical location of the vehicle is not within any of the at least one previously-defined point of rest area, defining the point of rest area as a new point of rest area that is included in the one or more point of rest areas in addition to the at least one previously-defined point of rest area. In such a case, there is no new point of rest area defined since the previously-determined point of rest area includes the resting geographical location. In other embodiments, however, a new point of rest area may be defined even when the resting geographical location resides within a previously-determined point of rest area. And, in some embodiments, determining whether the resting geographical location of the vehicle is within any of at least one previously-defined point of rest area may be carried out at a different time, such as prior to step 310 and/or 320. For example, in one embodiment, when it is determined that the resting geographical location of the vehicle is within any of the at least one previously-defined point of rest area, steps 320-350 are not carried out.

In some embodiments, the point of rest area may be defined is not specifically based on a resting geographical location of the vehicle as determined based on GNSS data, but based on data associated with the vehicle resting area. For example, the point of rest area may be defined as an area of a predetermined size that includes a user-input residence of the vehicle user. And, in another embodiment, the point of rest area may be defined as an area that corresponds to residential roads surrounding or proximate to the vehicle user's residence or other place of rest, such as a workplace.

The point of rest area may be defined by any number of suitable methods and, at least in some implementations, is or corresponds to a geofence. In at least some embodiments, the point of rest area is defined based on the minimum radius that would satisfy the anonymity constraints that are being used. The anonymity constraints may be flexible and may be based on information about the resting geographical location, such as the speed limit, the type of road(s), the amount of traffic, etc. The anonymity constraints may thus inform the point of rest area learning process as to the bounds, such as the size or radius and/or shape, of the point of rest area to be defined. Also, in at least some embodiments, one or more random (or pseudorandom) factors may be introduced so as to obfuscate the resting geographical location within the point of rest area to be defined.

In one embodiment, the point of rest area is defined by randomly (or pseudorandomly) selecting a geographical location that is within a first predetermined distance (or radius) from the resting geographical location and then defining the point of rest area as being the area that is within a second predetermined distance (or radius) of the selected geographical location. In such an embodiment, the second predetermined distance is equal to or greater than the first predetermined distance so that it is guaranteed that the resting geographical location is within the point of rest area.

In at least some embodiments, the point of rest area of the vehicle is defined as an area including the resting geographical location of the vehicle but where the resting geographical location is not necessarily at a center of the point of rest area. That is, the point of rest area of the vehicle may be determined as a randomized area such that the resting geographical location of the vehicle is not necessarily located at a center of the point of rest area. The point of rest area of the vehicle may be determined as a randomized area such that a likelihood of the resting geographical location of the vehicle being located at a center of the point of rest area is the same as or comparable to (i.e., within 10%) a likelihood of the resting geographical location of the vehicle being located anywhere else within the point of rest area.

In some embodiments, the point of rest area of the vehicle is determined as an area of at least a predetermined size. The predetermined size may be stored in the memory 120 of the onboard computer 106. In some embodiments, the predetermined size may vary amongst the vehicles 14. For example, the first vehicle 16 may be a vehicle that typically resides or is operated in an urban environment whereas the second vehicle 18 may be a vehicle that typically resides or is operated in a rural environment. In such an example, a first predetermined size may be used for the first vehicle 16 and a second predetermined size may be used for the second vehicle 18, where the second predetermined size is larger than the first predetermined size. Moreover, the predetermined size for any one vehicle or group of vehicles may vary based on other demographics of the geographical region in which the vehicle resides or is typically used or operated. The method 300 ends.

With reference to FIG. 4, there is shown an embodiment of a method 400 of transmitting connected vehicle data from a vehicle to a remote data repository. The method 400 is carried out by the vehicle electronics 100 and, in particular and at least according to some embodiments, by the communications subsystem 104 of the vehicle electronics 100. In at least one embodiment, the method 400 is carried out by a vehicle as a result of executing the in-vehicle computer instructions that form the in-vehicle computer program 42. The method 400 represents one embodiment of a geographical location obfuscation process that may be used to determine connected vehicle data to be sent to a remote data repository. In at least some embodiments, the vehicle electronics 100 are configured to carry out the point of rest area learning process to obtain one or more point of rest areas that are then used as a part of step 420 of the method 400.

The method 400 begins with step 410, wherein the current geographical location of the vehicle is periodically obtained. In at least some embodiments, the current geographical location is determined by the GNSS receiver 116 based on GNSS signals received from GNSS satellites and, in one embodiment, the current geographical location is specified at a resolution that is the same as a resolution of the GNSS data that is output by the GNSS receiver 116. The geographical location may be specified by a latitudinal and longitudinal coordinate pair, for example. In at least one embodiment, the geographical location may specify the location of the vehicle at or beyond a particular resolution, such as +/−3 meters, which may be the same resolution that the GNSS receiver 116 is configured to provide—for example, the GNSS receiver 116 may be configured to determine a geographical location at a specified resolution (e.g., +/−3 meters) and the current geographical location is also specified at this same resolution, at least in some embodiments. The method 400 continues to step 420.

In step 420, it is determined whether the obtained geographical location of the vehicle is within any of the one or more point of rest areas for the vehicle. In at least some embodiments, the one or more point of rest areas include those point of rest area(s) that were learned by the vehicle electronics as a result of the method 300. However, additionally or alternatively, the one or more point of rest areas include one or more point of rest areas that were configured based on a user's inputted residence, workplace, or other resting location. In some embodiments, the one or more of the point of rest areas include one or more point of rest areas that were transmitted to the vehicle electronics from a remote device or system, such as the remote data product system 40. To determine whether the obtained geographical location of the vehicle is within any given point of rest area, various techniques known to those skilled in the art may be used, such as, for example, point in polygon techniques. When it is determined that the obtained geographical location of the vehicle is within a point of rest area for the vehicle, the method 400 continues to step 440; otherwise, the method 400 continues to step 430.

In step 430, the obtained geographical location is transmitted to a remote device or system. According to some embodiments, the obtained geographical location is transmitted to the remote data product system 40 either via the OEM gateway 22 or directly (i.e., not via the OEM gateway 22). In one embodiment, the obtained geographical location may be transmitted to a remote data repository, such as the remote data repository 20 or the OEM data lake 21. As mentioned above, in at least some embodiments, the obtained geographical location specifies the location of the vehicle at or beyond a particular resolution, such as +/−3 meters. The obtained geographical location may be transmitted by the vehicle electronics 100 using the wireless communications device 108. In one embodiment, the obtained geographical location is transmitted to the remote data repository 20 via the OEM gateway 22. In another embodiment, the obtained geographical location is transmitted to the remote data repository 20 directly or without having to first pass through the OEM gateway 22. And, in yet another embodiment, the obtained geographical location is transmitted to the OEM data lake 21. In such embodiments, the remote data product system 40 may be permitted access to portions of the OEM data lake 21, such as, for example, those portions that store the obtained geographical locations or obfuscated geographical locations of the vehicle.

In step 440, the obtained geographical location is obfuscated to obtain an obfuscated geographical location. The obfuscated geographical location is an obfuscated representation of the obtained geographical location of the vehicle. As used herein, obfuscation or its other forms refers to modifying a geographical location so as to reduce the resolution or precision of the geographical location, or to otherwise conceal or obfuscate the geographical location, such as by reducing the accuracy of the geographical location. For example, according to one embodiment, the obtained geographical location may be initially determined by the GNSS receiver 116 and may be of a particular resolution, such as +/−3 meters. Then, as a part of this step, the obtained geographical location may be obfuscated so as to generate or otherwise obtain an obfuscated geographical location that is a representation of the obtained geographical location with a reduced resolution, such as +/−1000 meters. In one implementation, for example, the obfuscated geographical location may be generated by removing one or more significant figures or digits from the lowest decimal place(s). For example, assuming the obtained geographical location is a latitudinal-longitudinal coordinate pair of 45.12345, 35.12345, the obfuscated geographical location may be determined as being a latitudinal-longitudinal coordinate pair of 45.12, 35.12. Here, three digits were removed and the resolution of the latitudinal-longitudinal coordinate pair of the obfuscated geographical location is less than the resolution of the latitudinal-longitudinal coordinate pair of the obtained geographical location.

In another embodiment, an obfuscated geographical location is generated based on the obtained geographical location, but the resolution specified by the obfuscated geographical location may be the same as the resolution of the obtained geographical location. For example, assuming the obtained geographical location is a latitudinal-longitudinal coordinate pair of 45.12345, 35.12345, the obfuscated geographical location may be determined as being a latitudinal-longitudinal coordinate pair of 45.12754, 35.12986. In this example, the obfuscated geographical location and the obtained geographical location have the same resolution, but the last three digits of the obfuscated geographical location were randomly (or pseudorandomly) generated so as to conceal the actual location of the obtained geographical location.

In yet another embodiment, the obfuscated geographical location may be set as an identifier or associated geographical location of the point of rest area in which the obtained geographical location resides. In some embodiments, each point of rest area may be provided or assigned an identifier that is usable to uniquely identify a particular point of rest area from the other point of rest areas. In one embodiment, the obfuscated geographical location may be set as the identifier of the point of rest area that the obtained geographical location was determined as residing within (step 420). In another embodiment, a token geographical location may be assigned to each point of rest area. For example, a latitudinal-longitudinal coordinate pair representing or corresponding to a center point of the point of rest area may be specified as the token geographical location for the point of rest area that the obtained geographical location was determined as residing within (step 420) and this token geographical location may be used as the obfuscated geographical location. The method 400 continues to step 450.

In step 450, the obfuscated geographical location is transmitted to the remote device or system. In at least some embodiments, the obfuscated geographical location is transmitted to the same remote data repository as that to which the obtained geographical location(s) was/were transmitted in step 430. This step may be carried out in the same or a similar manner as step 430, except that the obfuscated geographical location is being transmitted. Moreover, in some embodiments, an indicator may be provided along with the obfuscated geographical location so as to indicate that the obfuscated geographical location is a geographical location that has been obfuscated.

In some embodiments, the obtained geographical locations (step 430) and the obfuscated geographical location (step 450) are each a part of a connected vehicle data stream transmitted by a vehicle. In other embodiments, instead of carrying out steps 440-450, the vehicle electronics may discard the obtained geographical location and/or disable transmission of the obtained geographical location of the vehicle (or any representation thereof, including an obfuscated geographical location). In such embodiments, for example, rather than generate or otherwise obtain an obfuscated geographical location, the vehicle electronics 100 forgoes, inhibits, prevents, or otherwise disables transmission of the obtained geographical location to the remote data repository. For example, the vehicle electronics 100 may be configured to periodically obtain and transmit the obtained geographical location. However, according to one embodiment, the in-vehicle computer instructions of the in-vehicle computer program 42 may prevent these vehicle operations from occurring when the vehicle is determined to be within any point of rest area (step 430). In such embodiments, the connected vehicle data stream may be effectively disabled during the time in which the vehicle resides within any of the point of rest areas. The method 400 then ends.

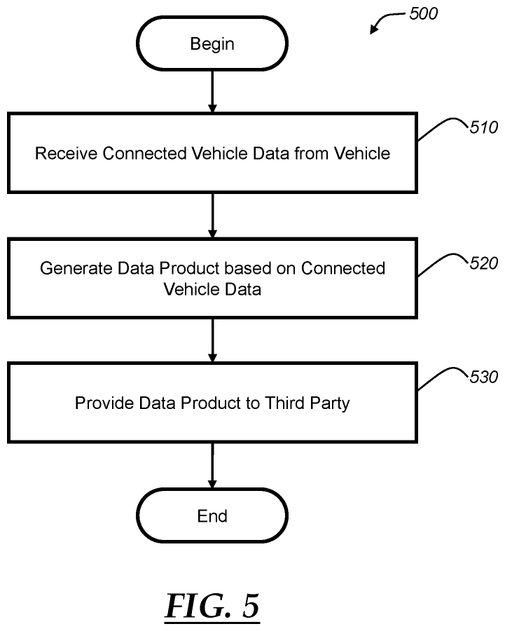

With reference to FIG. 5, there is shown an embodiment of a method 500 of generating and providing a data product using data supplied by a multitude of vehicles. According to at least some embodiments, the method 500 is carried out by the remote data product system 40 and, in particular, the remote data product system 40 includes one or more electronic processors (including the electronic processor 36) that are configured to execute computer instructions that, when executed by the one or more electronic processors, cause the remote data product system 40 to carry out the method 500.

The method 500 begins with step 510, wherein connected vehicle data concerning a plurality of vehicles is received. In at least one embodiment, and as discussed above, in steps 430 and 450, different geographical locations of the vehicle are transmitted based on whether the vehicle is within a point of rest area and these different geographical locations may include the obtained geographical location of the vehicle and the obfuscated geographical location of the vehicle. These geographical locations may be sent to a remote device or system, such as a remote data repository (e.g., the remote data repository 20, the OEM data lake 21). In at least one embodiment, the connected vehicle data may include one or more obtained geographical locations that were transmitted as a result of the step 430 and/or one or more obfuscated geographical locations that were transmitted as a result of the step 450. The connected vehicle data may be retrieved by the remote data product system 40 from the remote data repository that stores the one or more obtained geographical locations and the one or more obfuscated geographical locations.

At least according to some embodiments, the method 500 may be used to provide a real-time data product. In such a case, the connected vehicle data may be transmitted from one or more of the vehicles continuously and in real-time, and then accessed or otherwise received at the remote data product system 40 as soon as the connected vehicle data is available, which may be as soon as the connected vehicle data, which may include the obtained geographical location or the obfuscated geographical location, is stored at the remote data repository or other data store. In some embodiments, the obtained geographical location(s) and the obfuscated geographical location(s) are each a part of a connected vehicle data stream transmitted by a vehicle. And, in some embodiments, the connected vehicle data may be sent directly to the remote data product system 40 and/or stored in a temporary data store or buffer, which may be a part of the remote data product system 40. In such embodiments, the data product generator 220 (or other portion of the remote data product system 40) may access the temporary data store or buffer, and may then obtain and process the next location, which may be the obtained geographical location or obfuscated geographical location. This location may then be removed from the temporary data store or buffer. In other embodiments, the connected vehicle data streams may be fed to a remote data repository, such as the remote data repository 20 or OEM data lake 21, for long-term storage and then the data product generator 220 (or other portion of the data product system 12) may access and, thus, receive the obtained and/or obfuscated geographical locations. The method 500 continues to step 520.

In step 520, a data product is generated using the connected vehicle data. In some embodiments, such as where the data product is a real-time data product, the connected vehicle data may be continuously updated as a result of continuously carrying out the method 400 (FIG. 4) at each or at least one or more of the vehicles 14. The data product may thus include connected vehicle data, or data derived therefrom, that is continuously updated to reflect the connected vehicle data as it is continuously updated. In this sense, the real-time data product is a streaming data product that is continuously updated in response to receiving connected vehicle data from the vehicles 14. In one embodiment, the data product generator 220 obtains connected vehicle data that was stored at the remote data repository 20, such as connected vehicle data stored as a result of the method 400, and then processes the obtained connected vehicle data to generate the data product. In another embodiment, the connected vehicle data that was received as a result of the method 400 may first be processed, such as for calculating analytics describing the connected vehicle data, by another device or system before it is received at the data product generator 220. The method 500 continues to step 520.

In step 530, the data product is provided to a third party. Once the data product is assembled or otherwise generated, the data product may be provided to the data product customer 200, such as through electronically transmitting the data product to a computing device used by the data product customer 200 or by making the data product available to the data product customer 200, such as by sending a download URL to the data product customer 200 that enables the data product customer 200 to download the data product. In one embodiment, the remote data product system 40 transmit the data products to the third party computer system or, in another embodiment, the remote data product system 40 provides a download link to the third party or third party computer system that is usable to access and download the data product. The method 500 then ends.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A data product system for generating and providing a data product using data supplied by a multitude of vehicles, comprising:
a remote data product system having one or more processors and memory storing remote data product computer instructions accessible by the one or more processors of the remote data product system; and
a vehicle computer program product comprising in-vehicle computer instructions that are configured to be executed by a plurality of vehicles;
wherein each of the plurality of vehicles includes vehicle electronics having one or more electronic processors that are configured to execute the in-vehicle computer instructions and, when the in-vehicle computer instructions are executed by the one or more electronic processors of the vehicle electronics, the vehicle electronics:
carry out a point of rest area learning process to obtain one or more point of rest areas;
periodically obtain a current geographical location of the vehicle;
determine whether the vehicle is located within any of the one or more point of rest areas based on the obtained geographical location of the vehicle;
when it is determined that the vehicle is not located within any of the one or more point of rest areas, periodically transmit the obtained geographical location of the vehicle; and
when it is determined that the vehicle is located within any of the one or more point of rest areas, either transmit an obfuscated geographical location or forgo transmission of the obtained geographical location of the vehicle, wherein the obfuscated geographical location is an obfuscated representation of the obtained geographical location of the vehicle;
wherein the remote data product system is configured so that, when the remote data product computer instructions are executed by the one or more electronic processors of the remote data product system, the remote data product system:
receives connected vehicle data concerning the plurality of vehicles, wherein the connected vehicle data includes one or more geographical locations of the vehicle including the obtained geographical location of the vehicle;
generates a data product using the connected vehicle data; and
provides the data product to a third party.

2. The data product system of claim 1, wherein, when the in-vehicle computer instructions are executed by the one or more electronic processors of the vehicle electronics, the vehicle electronics transmit the obfuscated geographical location to the remote data repository when it is determined that the vehicle is located within any of the one or more point of rest areas.

3. The data product system of claim 2, wherein the connected vehicle data concerning the plurality of vehicles includes at least one obfuscated geographical location including the obfuscated geographical location.

4. The data product system of claim 1, wherein the determination of the point of rest area of the vehicle includes:
determining whether a resting geographical location of the vehicle is within any of at least one previously-defined point of rest area;
when it is determined that the resting geographical location of the vehicle is within any of the at least one previously-defined point of rest area, forgoing defining the point of rest area to be a new point of rest area; and
when it is determined that the resting geographical location of the vehicle is not within any of the at least one previously-defined point of rest area, defining the point of rest area as a new point of rest area that is included in the one or more point of rest areas in addition to the at least one previously-defined point of rest area.

5. The data product system of claim 4, wherein the new point of rest area of the vehicle is defined as an area of at least a predetermined size.

6. The data product system of claim 5, wherein the predetermined size is defined based on demographics concerning a geographical location of the vehicle.

7. The data product system of claim 1, wherein the point of reset area learning process includes:
determining a dwell time of the vehicle during which the vehicle is stationary; and
when the dwell time of the vehicle exceeds a predetermined threshold, determining a point of rest area of the vehicle based on a resting geographical location of the vehicle so that the point of rest area includes the resting geographical location of the vehicle, wherein the point of rest area is included as one of the one or more point of rest areas.

8. The data product system of claim 7, wherein the point of rest area of the vehicle is defined as an area including the resting geographical location of the vehicle but where the resting geographical location is not necessarily at a center of the point of rest area.

9. The data product system of claim 7, wherein the point of rest area of the vehicle is determined as a randomized area such that the resting geographical location of the vehicle is not necessarily located at a center of the point of rest area.

10. The data product system of claim 7, wherein the point of rest area of the vehicle is determined as a randomized area such that a likelihood of the resting geographical location of the vehicle being located at a center of the point of rest area is the same as or comparable to a likelihood of the resting geographical location of the vehicle being located anywhere else within the point of rest area.

11. The data product system of claim 1, wherein the in-vehicle computer instructions are downloaded to the each of the plurality of vehicles from a remote system.

12. The data product system of claim 11, wherein the remote system is a digital distribution platform.

13. The data product system of claim 11, wherein the remote system is an original equipment manufacturer (OEM) gateway or computer system.

14. The data product system of claim 11, wherein the remote system is the remote data product system.

15. The data product system of claim 14, wherein the in-vehicle computer instructions are downloaded to the each of the plurality of vehicles from the remote data product system via an original equipment manufacturer (OEM) gateway.

16. The data product system of claim 1, wherein the point of rest area learning process includes: determining whether the resting geographical location of the vehicle is within a residential area and, when it is determined that the resting geographical location of the vehicle is not within a residential area, determining not to define a point of rest area.

17. The data product system of claim 1, wherein the point of reset area learning process includes:
determining that the vehicle repeatedly stops at a vehicle resting area;
when it is determined that the vehicle repeatedly stops at a vehicle resting area, determining a point of rest area of the vehicle so that the point of rest area includes at least a portion of the vehicle resting area, wherein the point of rest area is included as one of the one or more point of rest areas.

18. The data product system of claim 17, wherein the point of reset area learning process includes determining whether at least part of the vehicle resting area is within a residential area and, when it is determined that the at least part of the vehicle resting area is not within a residential area, determining not to define a point of rest area.

19. A computer-readable memory, comprising computer instructions that, when executed by one or more electronic processors included as a part of vehicle electronics of a vehicle, cause the vehicle electronics to:
carry out a point of rest area learning process to obtain one or more point of rest areas;
periodically obtain a current geographical location of the vehicle;
determine whether the vehicle is located within any of the one or more point of rest areas based on the obtained geographical location of the vehicle;
when it is determined that the vehicle is not located within any of the one or more point of rest areas, periodically transmit the obtained geographical location of the vehicle; and
when it is determined that the vehicle is located within any of the one or more point of rest areas, either transmit an obfuscated geographical location or forgo transmission of the obtained geographical location of the vehicle, wherein the obfuscated geographical location is an obfuscated representation of the obtained geographical location of the vehicle.

20. A method of transmitting connected vehicle data from a vehicle to a remote data repository, wherein the method is carried out as a result of executing computer instructions using one or more electronic processors included as a part of vehicle electronics of a vehicle, wherein the method comprises the steps of:
carrying out a point of rest area learning process to obtain one or more point of rest areas;
periodically obtaining a current geographical location of the vehicle;
determining whether the vehicle is located within any of the one or more point of rest areas based on the obtained geographical location of the vehicle;
when it is determined that the vehicle is not located within any of the one or more point of rest areas, periodically transmitting the obtained geographical location of the vehicle; and
when it is determined that the vehicle is located within any of the one or more point of rest areas, either transmitting an obfuscated geographical location or forgoing transmission of the obtained geographical location of the vehicle, wherein the obfuscated geographical location is an obfuscated representation of the obtained geographical location of the vehicle.
